(19) United States
(12) Patent Application Publication
(10) Pub. No.: US 2015/0225614 A1
(43) Pub. Date: Aug. 13, 2015

(54) DOUBLE-SIDED ADHESIVE TAPE, METHOD OF MAKING, METHOD OF USE, AND ARTICLES THEREBY ASSEMBLED

(71) Applicant: Rogers Corporation, Rogers, CT (US)

(72) Inventors: Kibum Kim, Seongnam (KR); Jinsoo Song, Seongnam (KR)

(21) Appl. No.: 14/619,290

(22) Filed: Feb. 11, 2015

Related U.S. Application Data
(60) Provisional application No. 61/938,205, filed on Feb. 11, 2014.
(60) Provisional application No. 62/048,392, filed on Sep. 10, 2014.

(51) Int. Cl. C09J 7/02; B32B 37/26; B32B 38/10; B32B 37/24; B32B 37/12

(52) U.S. Cl. CPC C09J 7/0289; C09J 7/0282; C09J 7/0246; B32B 37/24; B32B 37/1284; B32B 38/10; B32B 37/26; C09J 2201/128; C09J 2201/16; C09J 2201/606; C09J 2475/006; B32B 2037/243; B32B 2037/1246; B32B 2037/268; B32B 2037/266; B32B 2457/00

(57) ABSTRACT

A foam tape having a multi-layer structure comprising a polyurethane foam core layer, at least one tie layer, adjacent one side of the polyurethane foam core layer, a first PSA film on one side of the first tie layer and a second PSA film, either on one side of a second tie layer or on one side of a polyester layer directly adjacent the opposite side of the polyurethane foam core layer, and a double-sided release layer on one side of the first PSA film. The foamed tape can be made by a process comprising applying a polymeric film to a first release layer to form a supported tie layer, referred to as Intermediate Product A, coating and drying a PSA composition on a second release layer to form a supported PSA coating, referred to as Intermediate Product B, laminating Intermediate Product B to Intermediate Product A which, after removing the release layer on the tie layer, forms Intermediate Product C comprising, in sequence, release layer, PSA film, and tie layer. A polyurethane foam precursor composition can be coated between a first and second Intermediate Product C, and the composition cured to form a polyurethane foam core layer.

### BACKGROUND OF THE INVENTION

The present invention relates to a double-sided adhesive tape, a method for making the same, use of the tape for applying a protective sheet to an electronic device, and the resulting article.

### DESCRIPTION OF THE RELATED ART

Foam tapes are widely used to adjoin parts and prevent or fill gaps between surfaces. Double-sided foam tapes typically comprise a foam core and pressure-sensitive adhesive (PSA) coatings on both sides thereof.

For example, a double-sided foam tape can be used to apply a protective sheet to an electronic device for sealing the device and absorbing impacts. Such electronic devices can include mobile phones, hard-disk drives, televisions, liquid crystal displays, or other devices that comprise precision electronic or electro-mechanical components that are subject to damage by external impact. A protective sheet such as a resilient silicone pad can be attached to an electronic device using a double-sided adhesive tape applied to a face of the pad.

While appropriate high adhesive strength is required for a foam tape during assembly of parts, clean delamination from a substrate surface is also essential for reworkability. For example, a protective sheet having a double-sided tape, after being applied to a substrate, may need to be later removed from the substrate. Thus, not only does a double-sided foam tape functionally require high adhesion strength between the tape's pressure-sensitive adhesive (PSA) and the surface of a substrate, but also requires clean delamination, which in turn requires even higher internal adhesive strength between layers of the tape, for example, between the PSA and the foam core of the tape.

Various foam materials have been used for the foam core of a foam tape, including acrylic foam, polyolefin foam and polyurethane foam. Although polyurethane foam can provide a good combination of mechanical properties for such use, polyurethane foam tapes have had limited use, due to the difficulties associated with achieving a combination of high adhesion strength and clean delamination from the surface of a substrate, especially as needed for more demanding or high performance applications.

In order to solve these problems, a double-sided polyurethane adhesive tape is desired that is capable of both excellent adhesive strength and clean delamination from a substrate.

Furthermore, an improved and advantageous process for making a high performance polyurethane foam tape is desired. Various manufacturing processes for polyurethane foam tapes have been described in the prior art. As mentioned above, however, the process of manufacturing the foam tape can adversely affect the useful properties of the tape, specifically with respect to delamination. For example, one prior art process employs direct foaming of polyurethane foam onto a PSA coating. This approach can lead to lower mechanical strength at the interface due to chemical interaction of the PSA composition with polyurethane precursor component materials.

Another approach has been to form a primer layer on top of polyurethane foam and then apply a PSA material on the primer layer. This approach, however, can be complicated, involve multiple coating steps on top of the foam core, and still may not provide sufficient adhesive strength for many applications. For example, it has been found that unless freshly prepared adhesive is used, adhesion of the tape may not work as well. Thus, a tape manufacturer may need to send an intermediate product used in making the tape to an adhesive manufacturer just for coating of the PSA. It would be desirable, however, to be able to manufacture a double-sided tape entirely in the same shop.

Therefore, development of an improved manufacturing process is also desired, which process would provide a polyurethane foam tape with both high adhesive strength clean delamination with respect to a substrate surface. At the same time, it is desired that the manufacturing process provides efficient high-quality production of the foam tape.

### SUMMARY OF THE INVENTION

In an exemplary embodiment, a double-sided adhesive tape is provided.

[Independent claims on tape and tape manufacture to be inserted here when finalized.]

Also disclosed is a method of applying an impact-absorbing and sealing protective sheet to an electronic device, wherein the protective sheet is adhered to a surface of the electronic device through the above-described foam tape.

Still further disclosed is an article that comprises an assembly in which the above-described foam tape adhesively joins a surface of a resilient protective sheet to a surface of an electronic device or part thereof. The electronic device can be a cell (mobile) phone or part thereof, a portable computer or a part thereof, a display device or part thereof, or other portable electronic device.

### BRIEF DESCRIPTION OF THE DRAWINGS

FIG. 1 shows a cross-sectional structure of a double-sided tape according to an embodiment of the invention.

FIG. 2 diagrammatically shows a method of producing a double-sided tape according to an embodiment of the invention and intermediate products involved in the production.

### DETAILED DESCRIPTION OF THE EMBODIMENTS

A polyurethane foam tape and an advantageous process of manufacturing the same involves, in one embodiment, a foam tape having a multi-layer structure comprises: (a) a polyurethane foam core layer; (b) a first and second tie layer on opposite sides of the polyurethane foam core layer, each tie layer in direct adjacent contact with the polyurethane foam core layer; (c) a first PSA film on one side of the first tie layer, on the side opposite to the side facing the polyurethane foam core layer, and a second PSA film on one side of the second tie layer, on the side opposite to the side facing the polyurethane foam core layer; (d) a release layer on one side of the first PSA film, on the side opposite to the side facing the polyurethane foam core layer and in direct adjacent contact with the first PSA film. The adhesive layer can be in direct contact with the tie layer.

In an alternative embodiment, a tie layer is present only on one side of the polyurethane foam core layer and, on the other side; a PSA film can be coated or laminated on a polyester film that separates the PSA film from the polyurethane foam core layer.

The foam tape can further comprises a second release layer on one side of the second PSA film, on the said opposite to the side facing side facing the polyurethane foam core layer and in direct adjacent contact with the second PSA film. By “release layer” is meant any single or composite layer comprising a release coating, optionally supported by one or more additional sub-layers including a release liner. A double-sided release layer is a composite layer comprising two outer release coatings separated by one or more additional sub-layers. In one embodiment, the foam tape comprises a double sided release layer adjacent the first PSA film.

Polyurethane foam compositions, for use in making the foam core layer of the tape, are known in the art, being described, for example, in U.S. Pat. No. 6,915,741 to Price et al., hereby incorporated by reference in its entirety. In general, polyurethane foams are formed from compositions comprising an organic isocyanate component reactive with an active hydrogen-containing component, a surfactant, and a catalyst. One process for forming the foam comprises forming the above-described composition; substantially uniformly dispersing inert gas throughout the mixture by mechanical beating of the mixture to form a heat curable froth which is substantially structurally and chemically stable, but workable at ambient conditions; and curing the froth to form cured foam. Alternatively, the foam may be formed by addition of chemical or physical blowing agents known in the art, such as water, organic compounds when decomposed to generate gas, or volatile organic materials such as chlorofluorocarbons.

More specifically, the polyurethane foam core layer can be prepared by a reaction between at least one kind of diisocyanate, for example, selected from the group consisting of methylene diphenyl isocyanate (MDI), toluene diisocyanate (TDI), methylene diphenyl isocyanate (MDI) oligomer, toluene diisocyanate (TDI) oligomer, hexamethylene diisocyanate (HDI), isophorone diisocyanate (IDPI), hydrogenated MDI (HMDI), and carbodiimide modified methylene diisocyanate; and at least one polyol mixture, for example, selected from the group consisting of polypropylene glycol, polytetramethylene glycol, and polyethylene glycol.

A cross-linking agent optionally can be used to increase cross-linking between an isocyanate pre-polymer and polyol in the polymerization reaction. Specifically, the cross-linking agent can be at least one agent selected from the group consisting of trimethylolpropane, triethanolamine, pentaerythritol, toluene diamine, ethylene diamine, glycerine, oxypropylated ethylene diamine, hexamethylene diamine, m-phenylene diamine, dimethanolamine, triethanolamine, and the like.

The polyurethane foam core layer is characterized by one or more of the following mechanical or physical properties. In particular, the polyurethane foam core layer can be open cell compressible foam having a specific gravity or density up to 1 g/cm³, specifically 0.08 to 0.8 g/cm³. In one embodiment, the density is 0.25 g/cm³ to 0.75 g/cm³, but can be higher or lower in other embodiments, depending on the particular polyurethane foam formulation employed for a particular application. In one embodiment, the polyurethane foam core layer can have a 25% compressive strength (compression force deflection) of up to 10.0 kgf/cm², specifically from 0.01 to 5.0 kgf/cm². In one embodiment, the 25% compressive strength is from 1 to 5 kgf/cm², but can be higher or lower, depending on the particular polyurethane formulation employed for a given application. The tensile strength of the polyurethane foam can be 10 to 300 kgf/cm², specifically 20 to 200 kgf/cm², more specifically 50 to 150 kgf/cm², and the elongation at break of the polyurethane foam can be 100 to 600%, specifically 300 to 500% in accordance with ASTM D3574.

The thickness of the polyurethane foam core layer can be changed depending on the application. Specifically, the polyurethane foam core layer can have a thickness of 20 μm to 10 mm, specifically 50 to 250 μm. It may be desirable to minimize the thickness of the foam layer and the entire tape for some applications, particularly when using the foam tape to attach a protective sheet, in order to allow for the maximum thickness of the protective sheet for impact absorption. Thinner tapes are desired for attaching a protective sheet to electronic devices as they become lighter, thinner, or smaller.

The tie layer or tie layers, inclusive of the first and second tie layer, comprise a polymeric film, specifically a non-foamed polyurethane thermoplastic, having a thickness of 1 to 50 micrometers, specifically 2 to 20 μm, more specifically 3 to 15 μm. A tie layer can comprise a plurality of polymer sub-layers or a single coated layer. The composition of the tie layer, in contrast to the foam core layer, is not foamed. (As used herein, “a tie layer” refers to a single tie layer or both the first and second tie layers in the tape, depending on the embodiment.) Specifically, the first and second tie layers can independently comprise polyurethane, alone or in a blend, in an amount greater than 60 wt. %. in a blend. The compositions of the first and second tie layers may be essentially or substantially the same. In one embodiment, the amount of polyurethane in the composition of the first and second tie layers differs by no more than 20 wt. %, specifically by no more than 10 wt. %. The first and second tie layers can optionally comprise, blended with polyurethane, up to 40 wt. % of a second polymer, for example, selected from the group consisting of nitrocellulose, vinyl polymer, polyester, polyamide, and combinations thereof. The tape can comprise a first and second tie layer having essentially or substantially the same thickness. Specifically, in one embodiment, the thickness of the first and second tie layers may differ by no more than 20%, specifically by no more than 10 wt. %.

The first and second tie layers can each comprise a composite film having a plurality of sub-layers. Composite films are readily obtained by known methods, for example by coating one layer with another or by co-extrusion of two or three layers. In one embodiment, for example, a composite layer can comprise a polyester layer and a polyurethane layer, wherein the polyurethane layer is directly adjacent the polyurethane foam layer in the tape product. In one embodiment, the tie layer is a single layer of polyurethane material, for example, coated from a solvent-borne polyurethane thermoplastic composition.

The tie layer can be any thin and flexible polymeric film which has enough adhesive strength with the PSA layer but is not soluble in the PSA, for example thermoplastic polyurethane, cross-linked polyurethane, polyester, polyamide, and polyvinyl polymers. Specifically, the composition of the tie layer can comprise a solvent-borne polyurethane which can be cured with an isocyanate crosslinker.

The composition of the first adhesive film and the second adhesive film can also be the same or, in order to obtain different adhesive strengths, different compositions, especially if only one tie-layer is used and one adhesive layer is directly adjacent the foam core layer.

The adhesive layer can be prepared from adhesive materials customarily used in the same or a related field, and it is not especially limited. Examples of adhesive materials can include an acrylic monomer, acrylic oligomer, acrylic polymer, acetate polymer, and styrene polymer. A polyurethane-based PSA, a rubber-based PSA, or a silicone-based PSA can be used. Specifically, it can comprise at least one material selected from the group consisting of vinyl acetate, methyl methacrylic acid, ethyl acetoacrylate, and sulfonated polystyrene. Specifically, a pressure sensitive adhesives can include acrylic pressure sensitive adhesives, such as POL-942 series of solvent-borne acrylic pressure sensitive adhesives from Cosmotec Co., Ltd. Aroset® 1450 commercially available from Ashland and Gelva® 1159 from Solutia, Inc., St. Louis, Mo. Optionally, isocyanate, epoxy, or metal chelate cross-linking agent can be used to increase thermal resistance and cohesive strength of the adhesive layer.

In one application, the adhesive layer requires sufficient adhesiveness so that a protective sheet can be attach to an electronic device. The thickness of the adhesive layer can be, for example, 5 to 150 μm.

The foam tape comprises at least one release layer, which can be transparent or colored plastic material, but is not limited thereto. Specifically, the release layer can comprise a support or “liner,” for example, a paper or plastic based carrier or web material. For example, a specific liner is Kraft Paper, a specific intermediate coating is high-density polyethylene (HDPE. The release liner can, for example, comprise a material selected from the group consisting of polyethylene terephthalate (PET), polyethylene naphthalate (PEN) polyester polyamide, polycarbonate, ethylene vinyl acetate copolymer, ethylene-ethyl acrylate copolymer, ethylene-propylene copolymer, and polyvinylchloride. Specifically, a silicone resin or oligomer can be coated on PET or on polyolefin coated paper. The adhesive agent does not need to form a continuous or coherent layer on the release liner.

Specifically, the release layer can comprise a liner that is coated on one or two sides with a release agent, which provides a release effect against any type of a sticky material such as an adhesive. Release comprises separation of the liner from an adhesive material.

Various release layers are known in the art and, in one embodiment, can comprise a liner, an intermediate coating, and a release coating. An exemplary release layer is commercially available from Rexam Release, Bedford Park, Ill. under the trade name Rexam Grade 16043.

A release layer can optionally comprise an intermediate coating and a release coating on both faces of the liner, i.e., a first intermediate coating and a first release coating on one aide of liner and a second intermediate coating and a second release coating on the other side of liner. This enables so-called differential release, in which a foam tape dispensed from a roll preferentially separates between the release coating in contact with one layer of tape and the first adhesive layer of the underlying layer of tape. Thus, a double-sided release layer comprises a release coating upon opposite sides. Specifically, the release coating can comprise a silicone polymer.

In one embodiment, the foam tape has a release liner only on one side of the foam tape, which can be a double-sided release layer. Alternatively, the foam tape may have a double-sided release layer on both sides or may have a double-sided release layer on one side and a single-sided release layer on the other side.

The total thickness of the foamed tape, inclusive of at least one release layer, can be 50 μm to 10 mm, specifically 100 to 500 μm, more specifically 100 to 300 μm.

For example, in one embodiment, a foam tape having a multi-layer structure comprises:

(a) a polyurethane foam core layer having a thickness of 100 to 250 μm;

(b) a first and second non-foamed polyurethane tie layer, each having a thickness of 1 to 20 μm, on opposite sides of the polyurethane foam core layer, each tie layer in direct adjacent contact with the polyurethane foam core layer;

(c) a first PSA film on one side of the first tie layer, on the side opposite to the side facing the polyurethane foam core layer, and a second PSA film on one side of the second tie layer, on the side opposite to the side facing the polyurethane foam core layer; and

(d) a double-sided release liner on one side of the first PSA film, on the side opposite to the side facing the polyurethane foam core layer and in direct adjacent contact with the first PSA film.

Such foam tape can be characterized by a peeling strength between the tape and the substrate that is greater than 3 kgf/inch, specifically less than 10 kgf/inch, with a stainless steel substrate, in accordance with FINAT FTM-1 standard procedure. In one embodiment, the first and second non-foamed tie layers have essentially the same composition and thickness.

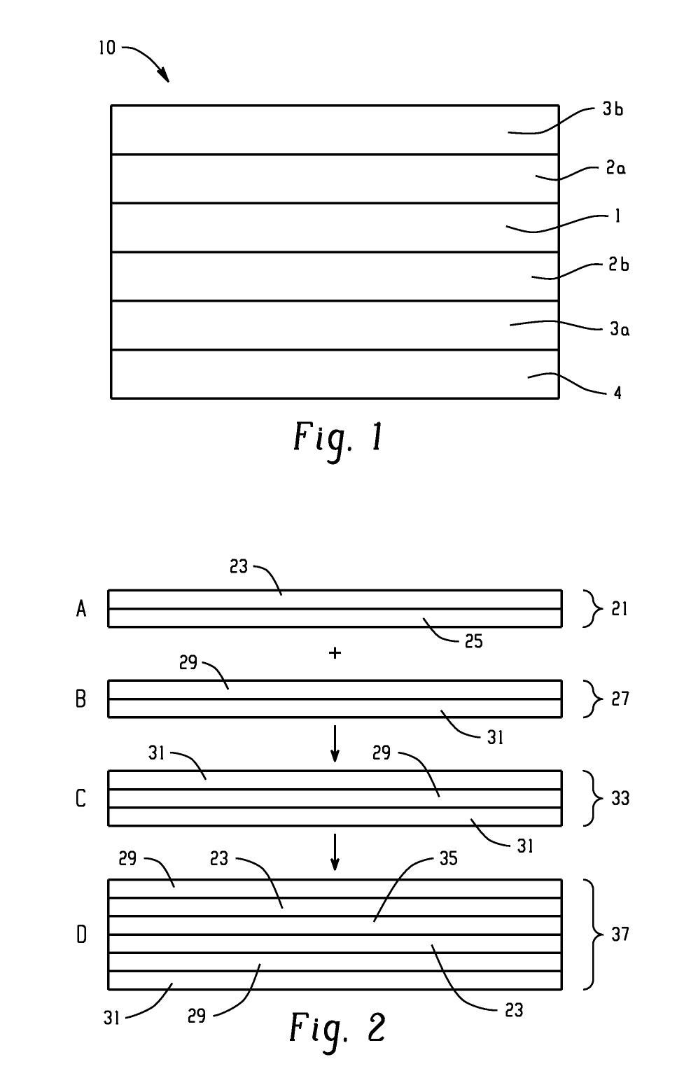

FIG. 1 shows a representative structure (not drawn to scale) of a foam tape 10 according to one embodiment, which foam tape comprises a multi-layer structure. Polyurethane foam layer 1 has been made from a polyurethane foam precursor composition that has been coated over tie layers 2a and tie layer 2b. Specifically, the polyurethane foam layer 1 is located between, and in direct contact with, tie layers 2a and 2b. The tie layers 2a and 2b are thin polymeric films, for example a polyurethane film that has been previously coated onto a release layer. (Such release layer can comprise, for example, a silicone or other high-surface tension polymeric film optionally coated on paper or other release-liner support layer.) The polyurethane films 2a and 2b are, hence, on opposite sides of the polyurethane foam layer 1. Each of the tie-layers 2a and 2b, on the side opposite the polyurethane foam layer, is immediately adjacent a PSA coating (which has been previously coated onto a release liner in the corresponding method), specifically PSA coatings 3a and 3b. The embodiment of FIG. 1 further comprises a double-sided release layer 4.

The compositions of the PSA coatings 3a and 3b can be the same or different. Since each side of the tape may be attached to a different surface, the composition and properties of each PSA adhesive may be designed for a particular application or substrate. For example, the PSA coating 3a, on one side of the tape, may be attached to a rigid housing (polymeric, ceramic, or metal) or other component thereof of an electronic device, and the PSA coating 3b, on the opposite side of the foam tape, may be attached to a resilient soft protective pad. Thus, for example, in one application, one substrate may be a silicone elastomer and the other substrate may be a stainless steel.

At least one of the PSA coatings 3a and 3b is in direct contact with a double-sided release liner 4, so that the entire tape, or sheet of tape material, can be wound into a roll for use. At an intermediate stage of manufacture, a release liner can be present on both sides of the tape in direct contact with the PSA-coatings 3a and 3b, one of which can be removed prior to winding the tape.

Various intermediate products can be made during, or in preparation for, the manufacture of the double sided tape of FIG. 1. Thus, referring to FIG. 2, sheet 21 comprises a tie layer coated 23 on a release layer 25 (comprising at least a release coating), referred to as Intermediate Product A, which can be wound up for later use in making a double-sided tape. Also, a sheet 27 comprising a PSA coating 29 on a release layer 31, referred to as Intermediate Product B, can be made for use in making the double sided tape. By adjoining Intermediate Products A and B, a laminated sheet 33 can be formed, referred to as Intermediate Sheet C, formed from laminating Intermediate Products A and B and removing one of the release liners, leaving a release layer only on one side.

Subsequently, a polyurethane precursor composition can be coated there between a first and second Intermediate Product C, to form a polyurethane foam core layer 35 sandwiched between first and second Intermediate Product C, having a release layer on both sides. One of the release layers can be removed prior to form the final tape product 37 rolling up the sheet for use as a double-sided tape.

In one embodiment, a manufacturing process for the polyurethane foam tape is as follows.

First, a thin polymeric film (for example a solvent-borne polyurethane mixed with cross-linker) is applied to a release liner to form a tie layer (for example, at 3 to 15 micron dry thickness) on a release layer, thereby forming Intermediate Product A. The coated polymeric film on release liner can be substituted by a molded film obtained by another process such as extrusion, inflation, or blow molding.

Second, a PSA composition (for example, a solvent-borne acrylic PSA mixed with cross-liner) is coated and dried on another release layer and dried to form a supported PSA coating, thereby forming Intermediate Product B.

Third, Intermediate Product B is laminated to Intermediate Product A which, after optionally removing the release liner on the tie layer, forms an Intermediate Product C, comprising in direct sequence, a release liner, PSA-coating, and tie layer. If the PSA layer requires post curing after coating, lamination can be performed before post curing.

Fourth, a polyurethane foam precursor composition, comprising a mixture of polyol and isocyanate components, is coated and cured between the two laminates formed previously, i.e. a polyurethane foam core layer is formed between a first and second Intermediate Product C, thereby forming a product comprising a double-sided tape (“tape” being inclusive of a web or sheet that can be subdivided into smaller-dimension tapes for individual use.)

Subsequently, one of the release liners can be removed so that the foam tape can be wound in a roll for future use.

Alternatively, a polymeric film can be used on one side of the polyurethane core foam layer and the other side can be PSA-coated PET. A polymeric film can or tie layer can be used on one side and the other side can be directly laminated with PSA.

The polymeric film used to make a tie layer should have good adhesion strength with polyurethane foam and good barrier properties with respect to PSA. The polymeric film should also be flexible enough to allow use of the resulting foam tape on a curved or uneven surface. Specifically, these requirements can be obtained using a film made of polyurethane or a mixture of polyurethane with other polymers.

The first and second Intermediate Product C used to make the polyurethane foam sandwich can be the comprised of the same layers or the materials in each of the component laminates can vary. For example, the layers in the first and second Intermediate Product C can have different compositions in the adhesive layers for different adhesive strengths or other properties.

For superior results, it can be advantageous to laminate Intermediate Product A to Intermediate Product B in-line or soon after preparing the PSA layer (within 24 hours, specifically within 6 hours, more specifically within 30 minutes, so that the PSA coating comes directly in contact with the tie-layer soon after the PSA is coated on the release layer. Specifically, Intermediate B and Intermediate C can be formed in a substantially continuously process or substantially in-line. This procedure can ensure good adhesion between the PSA-coating and the polymeric film that forms the tie layer.

On the other hand, the Intermediate Product A, comprising the tie-layer on a release liner, can be prepared and stored prior to use in making Intermediate Product C.

A process of making a foam tape can comprise (a) applying a polymeric film to a first release liner to form a supported tie layer, Intermediate Product A: (b) coating and drying a PSA composition on a second release liner to form a supported PSA coating, Intermediate Product B; (c) laminating Intermediate Product B to Intermediate Product A which, after removing the release liner on the tie layer, forms a Intermediate Product C comprising, in sequence, release liner, PSA film, and tie layer; (d) coating a polyurethane foam precursor composition, between a first and second Intermediate Product C, and curing the composition to form a polyurethane foam core layer between a first and second Intermediate Product C, thereby forming a product comprising a double-sided foam tape with release liners on opposite sides of the polyurethane foam core layer, optionally removing one of the release liners. Subsequently, one of the release liners can be removed (e) and, after removing one of the release liners, the foam tape can be wound up in a roll, wherein (b) and (c) can be conducted in the same in-line process, or within 30 minutes of each other, as mentioned above. Intermediate Product A, comprising the tie-layer on a release liner, can be prepared prior to preparing Intermediate Product B and optionally stored in a roll prior to use in making Intermediate Product C.

The polymeric film formed in (a) can comprise a non-foamed polyurethane, coated from a solvent-borne polyurethane, to obtain a dry thickness of 2 to 50 μm. Specifically, the tensile strength and/or the elongation of the tie layer can be at least 20% greater than that of the foamed polyurethane core material, in accordance with ASTM D3574. Such a one-component polyurethane is commercially available under the Hi-Thane S series from Songwon (South Korea), for example, SW-1031, a polyurethane in dimethylformamide (DMF) having a viscosity of less than about 200,000 cps at 25° C., producing a material having a tensile strength of 450 to 500 kg/cm² and an elongation (%) of 550-650. The composition of the polymeric film in both the first and second Intermediate Product C can be the same or substantially the same, differing in composition by no more than 10 wt. %. Similarly, the first and second Intermediate Product C can be essentially the same, i.e. creating a symmetrical product vis-à-vis the foam core.

Intermediate Product C, after removing one of the release liners, can be wound up in a roll for later use in manufacturing the foam tape. Each of a first and second Intermediate Product C can be fed from a wound up roll at the same time to a unit for dispensing polyurethane foam precursor between the first and second Intermediate Product C and the polyurethane foam precursor composition cured, thereby continuously forming a polyurethane foam core layer sandwiched between the first and second Intermediate Product C. Thus, in one embodiment, a continuous process can be used to make the foam tape from Intermediate Product C.

Specifically, a first and second Intermediate Product C can be fed between two rolls spaced horizontally in close juxtaposition to form a horizontal coating gap between the two rolls. A foam material can be fed into the aforesaid gap from a mixing chamber with one or more inlets for reactants. (The mixing chamber can be moved back and forth lengthwise of the gap along a track through mechanism of conventional construction.) Thus the mixture can be distributed uniformly along the gap before the mixture begins to foam substantially. Then the mixture is carried between sheets through a heater where foaming and at least partial curing takes place before reaching downstream feed rollers where one of the release layers can be peeled off and wound on one take-up reel and the manufacture tape sheet having foamed polyurethane and the other release sheet can be wound up on another take-up reel.

In another aspect, the above-describe tape can be used to apply an impact-absorbing and sealing protective sheet to an electronic device, wherein the protective sheet is adhered to a surface of the electronic device through the foam tape. Moreover, the sheet can be applied to various kinds of electronic devices.

The protective sheet can comprise a material, for example, selected from the group consisting of polyurethane, silicone, or other resilient foamed or non-foamed polymer. Flexible polyurethane, semi-rigid polyurethane, rigid polyurethane, or other polyurethane material can be used for the protective sheet, but it is not thereto limited. Specifically, flexible compressible polyurethane can be used.

Another aspect is directed to an article comprising an assembly in which a foam tape as above-described adhesively joins a surface of a protective sheet to a surface of an electronic device or part thereof. The electronic device can be a cell phone or part thereof, a computer or a part thereof, a liquid display device or part thereof, or other portable electronic device that is subject damage upon impact, for example, by being inadvertently dropped. An impact-absorbing and sealing sheet can be applied to electronic devices to prevent the components of the electronic devices from breaking by external impact and can shut out the influx of pollutants such as dust, and/or can protect an electronic device from electromagnetic waves.

According to one embodiment, the article can comprise a protective sheet having an adhesive layer one side, so that an adhesive foam tape need only be applied to the other side. Specifically, in one embodiment, one side of the protective sheet can have adhesiveness so that only the other side need be laminated with a double-sided adhesive tape. Consequently, the pad available for impact absorption can be relatively thicker than the case of applying double-sided adhesive tape or adhesive layer to both sides of the sheet.

In one embodiment of constructing the article, one side, or both sides of a protective sheet, is laminated with the double-sided adhesive tape, the sheet is cut into a requested shape, and the sheet is attached to the electronic device. The protective sheet, after the sheet has been applied to the interior or exterior of an electronic device, can act as a sealing means to directly absorb and disperse external impact, and prevent the influx of foreign pollutants.

The present invention is further described and illustrated in examples provided below, which are, however, not intended to limit the scope of the invention.

### EXAMPLE

A single-sided foam tape according to the invention can be prepared as follows. A tie layer is made by coating a thermoplastic solvent-borne polyurethane composition, having the components listed in Table 1, on a release liner to a dry thickness of 5 μm.

TABLE 1

| Component | Amounts |
|---|---|
| Polyurethane, SW1034L | 50 parts by weight |
| from Songwon Corporation | |
| (Gyeonggi-Do, South | |
| Korea) | |
| Methyl ethyl ketone | 30 parts by weight |
| Toluene | 20 parts by weight |

A pressure sensitive adhesive layer is separately made at a 30-micron dry thickness using solvent-borne acrylic copolymer POL-942 from Cosmotec (Tokyo, Japan). Freshly prepared pressure sensitive adhesive is laminated in-line with the previously prepared tie layer to obtain an intermediate product laminate comprising tie-layer/PSA/release layer. The release layer on the tie layer is peeled-off before the polyurethane foaming

Two intermediate product laminates, with tie layers facing each other, are fed into two rolls positioned horizontally. Polyurethane foam raw materials, 1043P0 polyol mixture and 103310 MDI prepolymer from USYS Co. Ltd, are mixed and coated between the two intermediate products laminates. The coated polyurethane foam raw material is cured into a final thickness of 250 μm in an oven and wound into a finished foam tape.

Testing:

The functional properties of a single-sided foam tape in accordance with the above were tested. The single-sided foam tape consisted of the polyurethane a foam core layer, tie layer, and adhesive layer. Specifically, the peel strength at 180 degrees was tested and the adhesion failure mode was noted.

The foam tape was tested, after cutting a sample of one-inch width, using a peel test machine (Model SP-2000 from Imass Inc.). The tape was attached to a freshly prepared substrate with a 2 kg hand roller. The adhesive strength of the tape was measured by pulling the tape at a rate of 300 mm/min Specifically, the adhesive strength was measured in accordance with the FINAT FRM-1 standard test procedure.

For comparison, a conventionally made single-sided foam tape with the same core layer coated with the same adhesive layer, but using no tie layer, was tested.

In particular, the single-sided construction of a foam tape comprised a 0.2 mm-thick foam core and a 30 micrometer PSA coating. The foam tape was applied to a stainless steel substrate (SS plate), thereby forming an assembly consisting of a single-sided foam tape attached to the SS plate. The tape adhesion was measured after 1 hour. Comparative testing was carried out with an assembly comprising the polyurethane foam/PSA/SS plate, wherein a polyurethane foam core was directly laminated with PSA, using the same PSA coating applied to the same polyurethane foam layer, but without the use of a supported tie layer adjoined to a supported PSA film. The results are shown in Table 2.

TABLE 2

| | | Adhesive |
|---|---|---|
| Sample | Failure Mode | Strength |
| Comparative Tape | Interface between foam | 32 N/inch |
| | and PSA coating layer | |
| Inventive Tape | Interface between SUS | 32 N/inch |
| | plate and PSA coating layer | |

Based on the results in Table 2, it can be seen that the inventive tape, made in accordance with the inventive process, provided clean delamination and excellent adhesive strength. The comparative tape, on the other hand, provided defective delamination in which part of the foam tape (the PSA coating) remained on the surface of the substrate, coming apart from the foam core.

1. A foam tape having a multi-layer structure comprising:
(a) a polyurethane foam core layer;
(b) at least one tie layer on at least one side of the polyurethane foam core layer, wherein the tie layer is in direct adjacent contact with the polyurethane foam core layer;
(c) a first PSA film on one side of the tie layer, on the side opposite to the side facing the polyurethane foam core layer, and a second PSA film on the opposite side of the polyurethane layer from the first PSA film;
(d) a release layer on one side of the first PSA film, on the side opposite to the side facing the polyurethane foam core layer and in direct adjacent contact with the first PSA film.

2. The foam tape of claim 1, wherein the tape comprises a first and second tie layer on opposite sides of the polyurethane foam core layer, each tie layer in direct adjacent contact with the polyurethane foam core layer and wherein the second PSA film is on one side of the second tie layer, on the side opposite to the side facing the polyurethane foam core layer.

3. The foam tape of claim 2, wherein the first and second PSA film is in direct adjacent contact with the first and second adhesive layer, respectively.

4. The foam tape of claim 1, wherein a release layer is present on one side of the second PSA film, on the said opposite to the side facing side facing the polyurethane foam core layer and in direct adjacent contact with the second PSA film.

5. The foam tape of claim 1, wherein the release layer is doubled-sided during manufacture of the foam tape and, in the final product, is single sided.

6. The foam tape of claim 1, wherein the polyurethane foam core layer is a compressible, open-celled polyurethane foam layer having a first side and an opposite second side, wherein the compressible polyurethane foam has a thickness of about 20 μm to about 10 mm.

7. The foam tape of claim 1, wherein the polyurethane foam core layer is characterized by density of from 0.08 to 0.8 g/cm³, 25% compression force deflection of from 0.01 to 5.0 kgf/cm², and elongation of 100 to 500%.

8. The foam tape of claim 1, wherein peel strength between the tape and a stainless steel surface is greater than 3 kgf/inch in accordance with FINAT FRM-1.

9-19. (canceled)

20. A foam tape having a multi-layer structure comprising:
(a) a polyurethane foam core layer;
(b) a first and second tie layer on opposite sides of the polyurethane foam core layer, each tie layer in direct adjacent contact with the polyurethane foam core layer;
(c) a first PSA film on one side of the first tie layer, on the side opposite to the side facing the polyurethane foam core layer, and a second PSA film on one side of the second tie layer, on the side opposite to the side facing the polyurethane foam core layer;
(d) a double-sided release liner on one side of the first PSA film, on the side opposite to the side facing the polyurethane foam core layer and in direct adjacent contact with the first PSA film.

21. The foam tape of claim 20, wherein the first and second tie layer each comprises non-foamed polyurethane and is in direct adjacent contact, on one side, with the polyurethane foam layer and, on the opposite side, with the first and second PSA film, respectively.

22. (canceled)

23. (canceled)

24. (canceled)

25. A process of making a foam tape, comprising
(a) applying a polymeric film to a first release layer to form a supported tie layer, Intermediate Product A;
(b) coating and drying a PSA composition on a second release layer to form a supported PSA coating, Intermediate Product B;
(c) laminating Intermediate Product B to Intermediate Product A, which after removing the release layer on the tie layer, forms a Intermediate Product C comprising, in sequence, release liner, PSA film, and tie layer; and
(d) coating a polyurethane foam precursor composition, onto at least one Intermediate Product C, and curing the composition to form a polyurethane foam core layer.

26. The process of claim 25, wherein a PSA layer is laminated or coated onto the other side of the polymeric foam layer.

27. A process of making a foam tape, comprising
(a) applying a polymeric film to a first release layer to form a supported tie layer, Intermediate Product A;
(b) coating and drying a PSA composition on a second release layer to form a supported PSA coating, Intermediate Product B;
(c) laminating Intermediate Product B to Intermediate Product A, which after removing the release layer on the tie layer, forms a Intermediate Product C comprising, in sequence, release liner, PSA film, and tie layer;
(d) coating a polyurethane foam precursor composition, between a first and second Intermediate Product C, and curing the composition to form a polyurethane foam core layer between a first and second Intermediate Product C, thereby forming a product comprising a double-sided foam tape with release layers on opposite sides of the polyurethane foam core layer, and optionally removing one of the release layers.

28. The process of claim 27, wherein, after removing one of the release liners, the foam tape is wound in a roll.

29. The process of claim 27, wherein (b) and (c) are conducted in the same in-line process or within three hours of each other.

30. The process of claim 27, wherein Intermediate Product A, comprising the tie-layer on a release liner, is prepared and stored in a roll prior to use in making Intermediate Product C.

31. The process of claim 27, wherein the polymeric film in (a) comprises a non-foamed polyurethane and has a thickness of 3 to 20 μm.

32. (canceled)

33. (canceled)

34. (canceled)

35. A method of applying an impact-absorbing and sealing protective sheet to an electronic device, wherein the protective sheet is adhered to a surface of the electronic device through the foam tape of claim 1.

36. (canceled)

37. (canceled)

38. An article comprising an assembly in which foam tape according to claim 1 adhesively joins a surface of a protective sheet to a surface of an electronic device or part thereof.

39. (canceled)
